(19) United States
(12) Patent Application Publication
(10) Pub. No.: US 2017/0282443 A1
(43) Pub. Date: Oct. 5, 2017

(54) METHOD OF PRODUCING A PROTECTIVE MAT

(71) Applicant: Paul H. Gianadda, Clarence, NY (US)

(72) Inventor: Paul H. Gianadda, Clarence, NY (US)

(21) Appl. No.: 15/476,720

(22) Filed: Mar. 31, 2017

Related U.S. Application Data
(60) Provisional application No. 62/316,434, filed on Mar. 31, 2016.

(51) Int. Cl. B29C 65/48; B29C 65/00

(52) U.S. Cl. CPC B29C 65/48; B29C 66/1142; B29C 66/7481

(57) ABSTRACT

A method of producing a protective mat is a method of re-using cork stoppers for bottles to construct a mat having a useful and an artistic function. The mats may be used as protective mats, or may be used for an artistic value. The method may include beginning with a circular centerpiece and attaching circular cork sections circularly to increase the diameter of mat until the desired diameter is reached.

### CROSS-REFERENCE TO RELATED APPLICATION

The present application is related to and claims priority from prior provisional application Ser. No. 62/316434, filed Mar. 31, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of cork composition devices and more specifically relates to method of producing a protective mat.

### 2. Description of the Related Art

Many types of bottles use cork stoppers in the bottling of liquids in glass bottles. An example is found in wine production. Quite often, glass wine bottles are recyclable, but rarely are the corks of the wine bottles reused or recycled. A wine bottle cork is a truncated cylindrical device having a cork composition which is a conically shaped seal for the top opening of the wine bottle. The cork is an impermeable material that is made from tree bark tissue and is made up of a hydrophobic substance that has buoyant, elastic, fire retardant properties. For the most part, cork is considered to be a disposable substance having only one use. A method to reuse or recycle used cork into new functional and desirable objects are needed.

Various attempts have been made to solve problems found in cork based devices art. Among these are found in: U.S. Pat. No. 1,722,648 to Enrique Vincke; U.S. Pat. No. 2,677,910 to Rodney D Morgan; and U.S. Publication No. 2014/0367880 to Winfried Haenel. This art is representative of cork composition devices. None of the above inventions and patents, taken either singly or in combination, is seen to describe the invention as claimed.

Ideally, cork composition devices should be recyclable, and yet, would still be manufactured cost effectively. Thus, a need exists for a reliable method to recycle cork into useable objects to avoid the above-mentioned problems.

### BRIEF SUMMARY OF THE INVENTION

In view of the foregoing disadvantages inherent in the known cork composition device art, the present invention provides a novel method of producing a protective mat. The general purpose of the present invention, which will be described subsequently in greater detail, is to provide a method to recycle cork into useable objects.

A method of producing a protective mat comprising the steps of providing a plurality of bottle cork members each having a circular cross-section forming a center piece and formed having a disc-shaped cross-section, a perimeter, and a diameter, and attaching bottle cork members around the perimeter of the center piece in a side-by-side fashion forming an outer perimeter of a protective mat. The plurality of bottle cork members each have similar shapes and the step of attaching bottle cork members around the perimeter of the center piece in a side-by-side fashion include each cork bottle member being in contact with adjacent cork bottle members.

The circular cross-sections of the bottle cork members are placed in a perpendicular configuration with respect to the circular cross-section of the center piece. The steps may also include attaching bottle cork members around the outer perimeter of the protective mat in a side-by-side fashion forming a new outer perimeter having a diameter. The circular cross-sections of the bottle cork members are placed in a perpendicular configuration with respect to the circular cross-section of the center piece which also has a circular shape. The cross-section can be formed having an oval shape.

The step of attaching bottle cork members around the outer perimeter of the protective mat in a side-by-side fashion includes each cork bottle member being in contact with adjacent cork bottle members. The step of attaching bottle cork members around each new outer perimeter of the protective mat is repeated until a desired diameter of protective mat is reached. The desired diameter of the protective mat may be chosen from a list of diameters consisting of 18 inches, 20 inches, 24 inches, 28 inches, 32 inches, and 36 inches. In other embodiments, the desired diameter of the protective mat may be chosen from a list of diameters consisting of 7 inches, 8 inches, 9 inches, and 10 inches. The diameter of the center piece may be chosen from a list of diameters consisting of 8 inches, 9 inches, and 10 inches.

The center piece may be formed from other materials as well as cork and may be chosen from the group of materials consisting of cork, wood, aluminum, plastic, and ceramic. In addition to the shapes and configurations that the mat may be constructed of, the center piece may also include indicia or various forms of artwork. The indicia may be chosen from the group of indicia consisting of a person's name, a team's name, a logo, and a company's name. The methods of construction may also comprising the steps of: providing a hook member, the hook member is adapted to be attached to one of the plurality of bottle cork members, and is used to hook the protective mat to a vertical supporting surface such as for a wall hanging.

A method of construction of the protective mats may be to place the desired number of bottle corks into a pressure cooker with about 2 cups of water, replace the top of the pressure cooker, place over heat for 2 minutes, remove from heat and place under cold running water until steam is exhausted, remove and dry corks, cut out suitable diameters of circles from plywood to make a template for each shaped row of corks to be placed within. Custom angled cuts on the sides of each cork may be made to make the desired number of corks to be used suitable for insertion within the cutout of the plywood and to make the sides of each cork align when placed within the circular cutout. The first row of corks is attached using waterproof clear silicone capable of remaining flexible between zero degrees F. and 135 degrees F. The last cork in the first row must be compressed and forced into the remaining gap and the pressure will equalize eliminating all gaps between corks. Use a hole saw to perfectly round the remaining center hole formed by the smaller diameter end of the adjacent corks, then leave the assembled row in the form for 24 hours for complete setup of the Silicone. After 24 hours, additional rows of bottle corks are attached using the same procedure but with a larger diameter of cutout from the plywood and placing the first assembled row within the cutout with an equal space centered around the first assembled row, for insertion of the next row. Repeat for additional rows. The diameters of plywood cutouts that may be used that work in conjunction with each other are 16″, 20″, 24″ 28″, 32″ and 36″. For smaller sizes of mats, 7″, 8″, 9″, and 10″ cutouts may be used. Rectangular mats can be assembled in similar fashion with rectangular cutouts and mitering approximately three corks used for each corner.

The present invention holds significant improvements and serves as a method of producing a protective mat. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a method to recycle cork into useable objects, constructed and operative according to the teachings of the present invention.

FIG. 1 shows a top plan view illustrating a first embodiment of a method of producing a protective mat according to an embodiment of the present invention.

FIG. 2 is a top plan view illustrating a second embodiment of a method of producing a protective mat according to an embodiment of the present invention of FIG. 1.

FIG. 3 is a top plan view illustrating a third embodiment of a method of producing a protective mat according to an embodiment of the present invention of FIG. 1.

FIG. 4 is a flowchart illustrating a method of producing a protective mat according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to a cork composition devices and more particularly to a method to recycle cork into useable objects as used to improve the recyclability of cork into useable objects.

Generally speaking, a method of producing a protective mat is a method of re-using cork stoppers for bottles to construct a mat having a useful and an artistic function. The mats may be used as protective mats, or may be used for an artistic value. The method may include beginning with a circular centerpiece and attaching circular cork sections circularly to increase the diameter of mat until the desired diameter is reached.

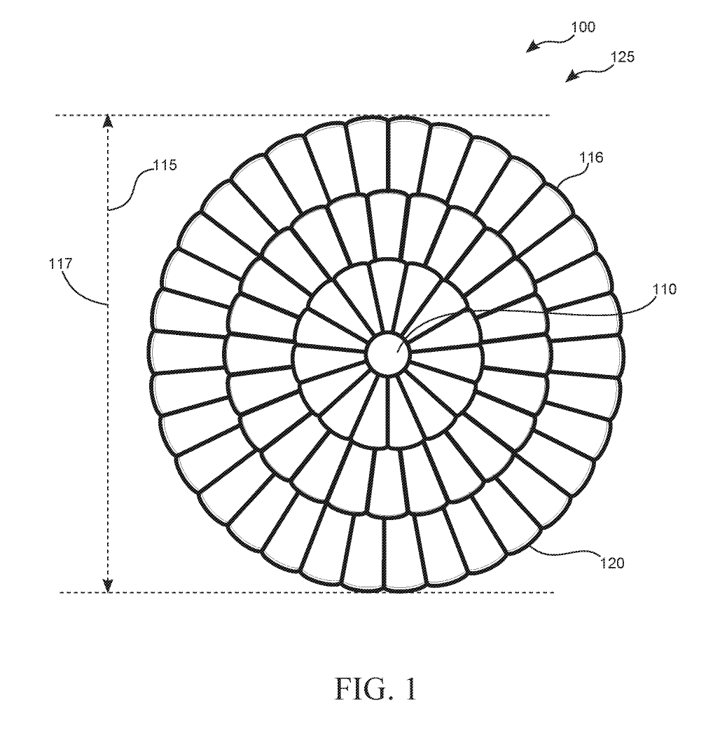

In greater detail now, referring to the drawings by numerals of reference there is shown in FIG. 1, a top plan view illustrating a first embodiment of method of producing a protective mat 100 according to an embodiment of the present invention.

Method of producing a protective mat 100 comprising the steps of providing a plurality of bottle cork members 105 each having a circular cross-section 115 forming center piece 110 and formed having a disc-shaped cross-section 115, outer perimeter 116, and diameter 117, and attaching bottle cork members 105 around outer perimeter 116 of center piece 110 in a side-by-side fashion forming outer perimeter 116 of protective mat 120. The plurality of bottle cork members 105 each have similar shapes and the step of attaching bottle cork members 105 around outer perimeter 116 of center piece 110 in a side-by-side fashion include each bottle cork member 105 being in contact with adjacent bottle cork members 105.

The circular cross-section 115 of bottle cork members 105 are placed in a perpendicular configuration with respect to the circular cross-section 115 of center piece 110. The steps may also include attaching bottle cork members 105 around outer perimeter 116 of protective mat 120 in a side-by-side fashion forming a new outer perimeter 116 having diameter 117. The circular cross-section 115 of bottle cork members 105 are placed in a perpendicular configuration with respect to cross-section 115 of center piece 110 which also has a circular shape. Cross-section 115 can be formed having an oval shape.

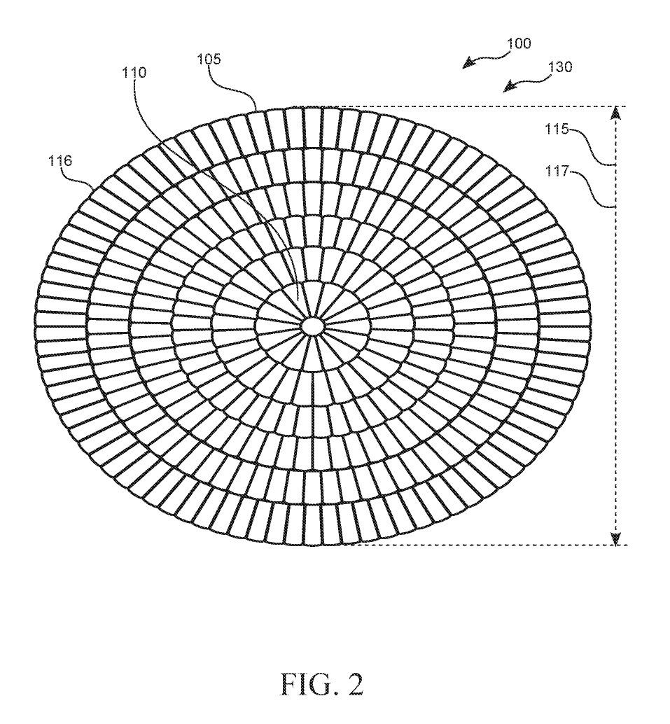

Referring now to FIG. 2, a top plan view illustrating a second embodiment of a method of producing a protective mat 100 according to an embodiment of the present invention of FIG. 1.

The step of attaching bottle cork members 105 around outer perimeter 116 of protective mat 120 in a side-by-side fashion includes each bottle cork member 105 being in contact with adjacent bottle cork members 105. The step of attaching bottle cork members 105 around each new outer perimeter 116 of protective mat 120 is repeated until a desired diameter 117 of protective mat 120 is reached. The desired diameter 117 of protective mat 120 may be chosen from a list of diameters 117 consisting of 18 inches, 20 inches, 24 inches, 28 inches, 32 inches, and 36 inches. In other embodiments, the desired diameter 117 of protective mat 120 may be chosen from a list of diameters 117 consisting of 7 inches, 8 inches, 9 inches, and 10 inches. Diameter 117 of center piece 110 may be chosen from a list of diameter 117 consisting of 8 inches, 9 inches, and 10 inches.

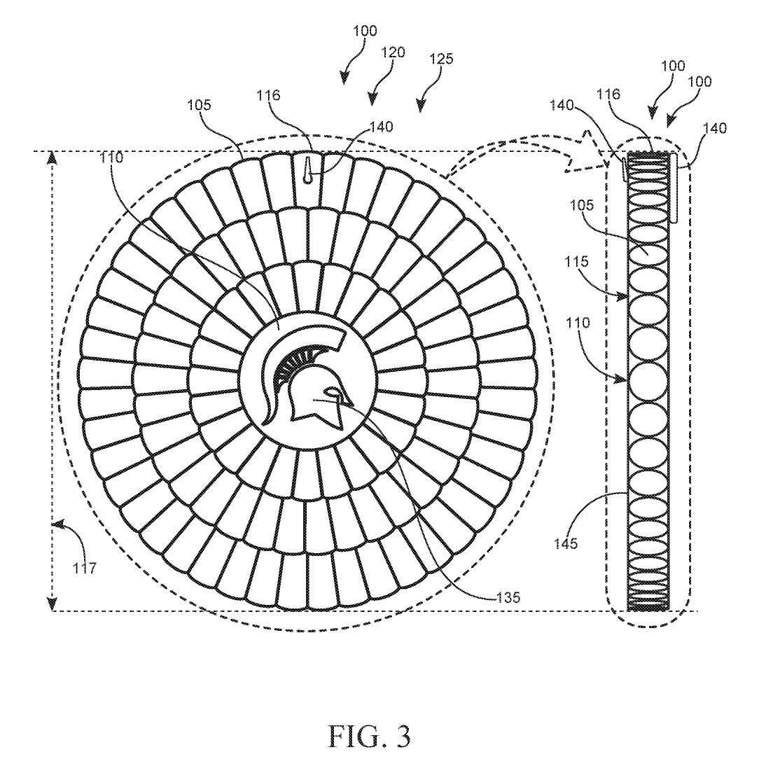

Referring now to FIG. 3, a top plan view illustrating a third embodiment of method of producing a protective mat 100 according to an embodiment of the present invention of FIG. 1.

Center piece 110 may be formed from other materials as well as cork and may be chosen from the group of materials consisting of cork, wood, aluminum, plastic, and ceramic. In addition to the shapes and configurations that protective mat 120 may be constructed of, center piece 110 may also include indicia 135 or various forms of artwork. Indicia 135 may be chosen from the group of indicia 135 consisting of a person's name, a team's name, a logo, and a company's name. The methods of construction may also comprising the steps of: providing hook member 140, hook member 140 is adapted to be attached to one of the plurality of bottle cork members 105, and is used to hook protective mat 120 to a vertical supporting surface such as for a wall hanging.

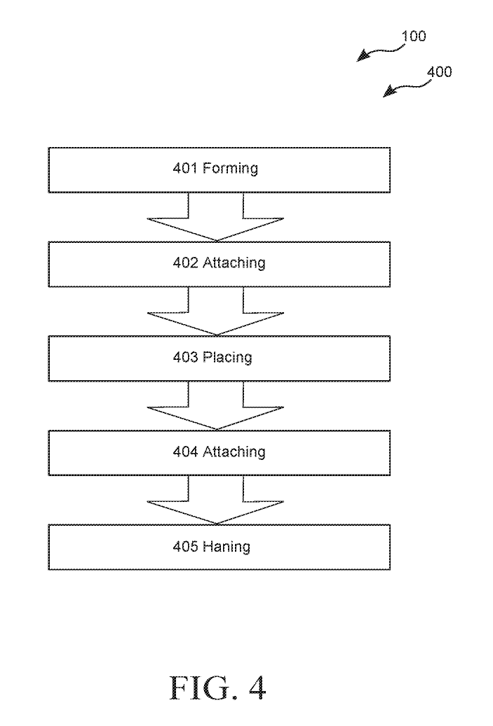

Referring now to FIG. 4, showing method of producing a protective mat 400. A method of producing protective mat 400 may comprise the steps of: step one 401 forming center piece 110; step two 402 attaching bottle cork members 105 around outer perimeter 116 of center piece 110 in a side-by-side fashion forming outer perimeter 116 of protective mat 120; step three 403 placing indicia 135 on outer surface 145 of center piece 110; step four 404 attaching hook member 140 to one of bottle cork members 105; step five 405 hanging the formed protective mat 120 onto a vertical surface.

It should be noted that steps 403-405 are optional steps and may not be implemented in all cases. Optional steps of method 400 are illustrated using dotted lines in FIG. 4 so as to distinguish them from the other steps of method 400.

It should be noted that the steps described in the method of use can be carried out in many different orders according to user preference. The use of “step of” should not be interpreted as “step for”, in the claims herein and is not intended to invoke the provisions of 35 U.S.C. §112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A method of producing a protective mat, comprising the steps of:
providing a plurality of bottle cork members;
wherein each of said plurality of bottle cork members have a circular cross-section;
providing a center piece;
wherein said center piece is formed having a disc-shape having a cross-section, a perimeter, and a diameter; and
attaching bottle cork members around said perimeter of said center piece in a side-by-side fashion forming an outer perimeter of said protective mat.

2. The method of producing a protective mat of claim 1, wherein said plurality of bottle cork members have similar shapes.

3. The method of producing a protective mat of claim 1, wherein said step of attaching bottle cork members around said perimeter of said center piece in a side-by-side fashion includes each cork bottle member being in contact with adjacent cork bottle members.

4. The method of producing a protective mat of claim 1, wherein said circular cross-sections of said bottle cork members are placed in a perpendicular configuration with respect to said circular cross-section of said center piece.

5. The method of producing a protective mat of claim 1, further comprising the steps of:
attaching bottle cork members around said outer perimeter of said protective mat in a side-by-side fashion forming a new outer perimeter having a diameter.

6. The method of producing a protective mat of claim 5, wherein said circular cross-sections of said bottle cork members are placed in a perpendicular configuration with respect to said circular cross-section of said center piece.

7. The method of producing a protective mat of claim 6, wherein said step of attaching bottle cork members around said outer perimeter of said protective mat in a side-by-side fashion includes each cork bottle member being in contact with adjacent cork bottle members.

8. The method of producing a protective mat of claim 7, wherein said step of attaching bottle cork members around each new outer perimeter of said protective mat is repeated until a desired diameter of said protective mat is reached.

9. The method of producing a protective mat of claim 8, wherein said desired diameter of said protective mat is chosen from a list of diameters consisting of 18 inches, 20 inches, 24 inches, 28 inches, 32 inches, and 36 inches.

10. The method of producing a protective mat of claim 8, wherein said desired diameter of said protective mat is chosen from a list of diameters consisting of 7 inches, 8 inches, 9 inches, and 10 inches.

11. The method of producing a protective mat of claim 1, wherein said diameter of said center piece is chosen from a list of diameters consisting of 8 inches, 9 inches, and 10 inches.

12. The method of producing a protective mat of claim 1, wherein said cross-section of said center piece is formed having a circular shape.

13. The method of producing a protective mat of claim 1, wherein said cross-section of said center piece is formed having an oval shape.

14. The method of producing a protective mat of claim 1, wherein said center piece is formed from a material chosen from a group of materials consisting of cork, wood, aluminum, plastic, and ceramic.

15. The method of producing a protective mat of claim 1, wherein said center piece includes indicia thereon.

16. The method of producing a protective mat of claim 15, wherein said indicia is chosen from a group of indicia consisting of a person's name, a team's name, a logo, and a company's name.

17. The method of producing a protective mat of claim 1, further comprising the steps of:
providing a hook member;
wherein said hook member is adapted to be attached to one of said plurality of bottle cork members, and is used to hook said protective mat to a vertical supporting surface.
